(19) United States
(12) Patent Application Publication
(10) Pub. No.: US 2009/0001161 A1
(43) Pub. Date: Jan. 1, 2009

(54) Information processing system and remote access method

(76) Inventor: Shuichi Uchiyama, Ebina (JP)

Correspondence Address: MCDERMOTT WILL & EMERY LLP, 600 13TH STREET, N.W., WASHINGTON, DC, 20005-3096, US

(21) Appl. No.: 12/071,065

(22) Filed: Feb. 14, 2008

(30) Foreign Application Priority Data
Feb. 14, 2007 (JP) 2007-033596

(51) Int. Cl. G06K 5/00

(52) U.S. Cl. 235/382

(57) ABSTRACT

An information processing system comprising a local machine performing an information processing, a remote machine making connection to the local machine via a network and performing operation to the local machine by a user and a management-authorization server performing management and authorization of the remote machine is provided. The management-authorization server includes a plurality of connection information files for the remote machine to make connection to the local machine, and the remote machine, at making connection to the local machine, makes connection to the local machine based on a connection information file provided from the management-authorization server, after the authorization by the management-authorization server.

### CROSS-REFERENCE TO RELATED APPLICATION

The present application claims priority from Japanese Patent Application No. JP 2007-033596 filed on Feb. 14, 2007, the content of which is hereby incorporated by reference into this application.

### TECHNICAL FIELD OF THE INVENTION

The present invention relates to an information processing system, in particular, to technique effectively applied to authorization at remote access and selection of a destination of remote access connection.

### BACKGROUND OF THE INVENTION

Conventionally, in an information processing system, when performing remote access, an authorization processing and a connection processing are performed between a remote machine and a local machine.

And, a key mobile and the like are used at a side of the remote machine and connection with the local machine is made by a certificate or connection information in the key mobile, or an IC card and the like are used and the connection with the local machine is made by a certificate in the IC card and connection information in the remote machine.

### SUMMARY OF THE INVENTION

However, in the conventional information processing system, since the connection information and the like between the remote machine and the local machine are held at the side of the remote machine, there is a problem that connection information of a connection destination is limited.

Therefore, in a case where the remote machine performs communication while moving, the connection information to the local machine is fixed, and there is a problem that connection by optimum connection information may not be made.

Further, since the connection information to the local machine is fixed, connections cannot be made to a device other than the local machine, for example, a maintenance server, and therefore, maintenance and the like of the remote machine by connection with the maintenance server and the like cannot be performed.

Accordingly, an object of the present invention is to provide an information processing system capable of performing the authorization processing and the connection processing without limiting the connection information of the connection destination, when connecting the remote machine and the local machine.

The typical ones of the inventions disclosed in this application will be briefly described as follows.

An information processing system according to the present invention comprises: a local machine performing an information processing; a remote machine making connection to the local machine via a network and performing operation to the local machine by a user; and a management-authorization server performing management and authorization of the remote machine, wherein the management-authorization server includes plural pieces of connection information for the remote machine to make connection to the local machine, and wherein the remote machine, at making connection to the local machine, makes connection to the local machine based on the connection information provided from the management-authorization server after the authorization by the management-authorization server.

The effects obtained by typical aspects of the present invention will be briefly described below.

According to the present invention, when connecting the remote machine and the local machine, the authorization processing and the connection processing can be performed without limiting the connection information of the connection destination.

### BRIEF DESCRIPTIONS OF THE DRAWINGS

FIG. 1 is a structural diagram showing a structure of an information processing system according to an embodiment of the present invention;

FIG. 2 is a block diagram showing a structure of a remote machine of the information processing system according to the embodiment of the present invention;

FIG. 3 is a diagram showing an example of a structure of a connection information file held in a management-authorization server of the information processing system according to the embodiment of the present invention;

FIG. 4 is a diagram showing an example of a structure of device information held in the remote machine of the information processing system according to the embodiment of the present invention;

FIG. 5 is a flow chart showing operation of a comparative example of the information processing system according to the embodiment of the present invention;

FIG. 6 is a flow chart showing operation of a comparative example of the information processing system according to the embodiment of the present invention;

FIG. 7 is a flow chart showing operation of the information processing system according to the embodiment of the present invention;

FIG. 8 is an explanatory diagram for explaining a concrete example of selection of optimum connection information of the information processing system according to the embodiment of the present invention;

FIG. 9 is an explanatory diagram for explaining a concrete example of selection of optimum connection information of the information processing system according to the embodiment of the present invention; and

FIG. 10 is a flow chart showing operation of a maintenance work of the information processing system according to the embodiment of the present invention.

### DESCRIPTIONS OF THE PREFERRED EMBODIMENTS

Hereinafter, embodiments of the present invention will be described in detail with reference to the accompanying drawings. Note that the same components are denoted by the same reference symbols throughout the drawings for describing the embodiment, and the repetitive description thereof will be omitted.

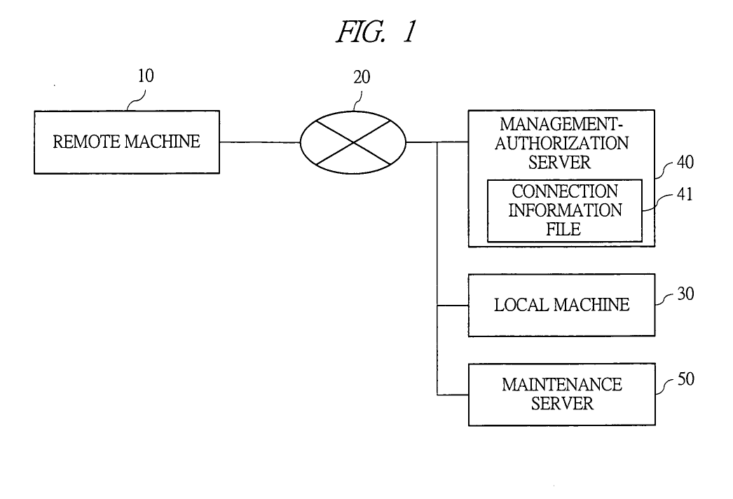

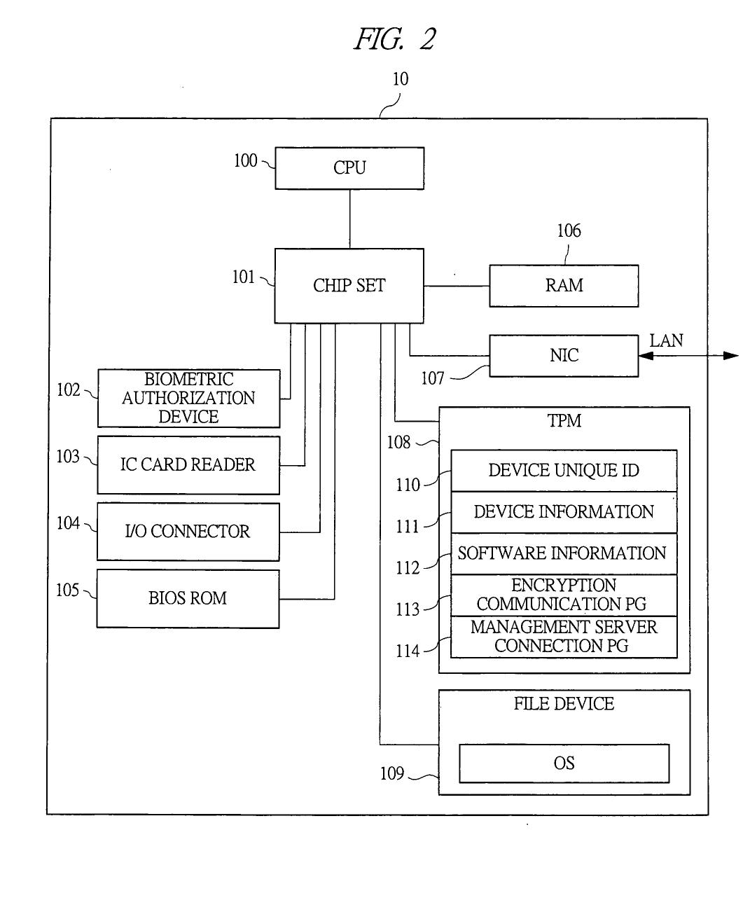

With reference to FIG. 1 and FIG. 2, a structure of an information processing system according to an embodiment of the present invention is explained. FIG. 1 is a structural diagram showing the structure of the information processing system according to the embodiment of the present invention, and FIG. 2 is a block diagram showing a structure of a remote machine of the information processing system according to the embodiment of the present invention.

In FIG. 1, the information processing system is composed of a remote machine 10, a local machine 30, a management-authorization server 40 and a maintenance server 50, and the remote machine 10 is connected to a network 20 to perform communication with the local machine 30, the management-authorization server 40 and the maintenance server 50 via the network 20.

The management-authorization server 40 holds a connection information file 41 which is information used when connecting the remote machine 10 to the local machine 30. When connecting the remote machine 10 to the local machine 30, the management-authorization server 40 performs an authorization processing of the remote machine 10 and transmits a list of the connection information file 41 from an optimum remote machine 10 to the local machine 30 after the authorization processing.

Thereby, the remote machine 10 does not have to store connection information to the local machine 30, and therefore, even in a case where the remote machine 10 is used while moving, connection to the local machine can be made by connection information optimum for a location of the movement.

The maintenance server 50 is a server capable of performing a maintenance work such as update of the remote machine 10. The remote machine 10 can be connected to the maintenance server 50 by the connection information from the management-authorization server 40, and an update processing of software and update processings of drivers, BIOS and the like can be performed.

In FIG. 2, the remote machine 10 is structured of a CPU 100 executing various processings in the remote machine 10 by performing various kinds of programs, a chip set 101 exchanging a signal in the remote machine 10, a biometric authorization device 102 obtaining biometric information of a user of the remote machine 10, an IC card reader reading authorization media and the like of the user of the remote machine 10, an I/O connector 104 for connecting a keyboard, a mouse and the like, a BIOS ROM 105 storing BIOS, a RAM 106 used at the processing of the CPU 100, an NIC 107 for making connection with the network 20, a TPM (Trusted Platform Module) 108, a file device 109 storing an OS and the like, and so on.

The TPM 108 has a function similar to that of a security chip loaded on a smart card (IC card), and is a hardware chip having an operation function by an asymmetric key and tamper resistance for storing the key in security.

Further, in the TPM 108, a device unique ID 110, device information 111, software information 112, an encryption communication program 113 and a management server connection program 114 are stored.

Next, with reference to FIG. 3, a structure of the connection information file 41 held in the management-authorization server 40 of the information processing system according to the embodiment of the present invention is explained. FIG. 3 is a diagram showing an example of the structure of the connection information file held in the management-authorization server of the information processing system according to the embodiment of the present invention.

The connection information file 41 stores, as shown in FIG. 3, plural pieces of information such as communication device information, network information, information at dial-up, VPN connection setting information, terminal information as items, and they are used as information in connecting the remote machine 10 to the local machine 30.

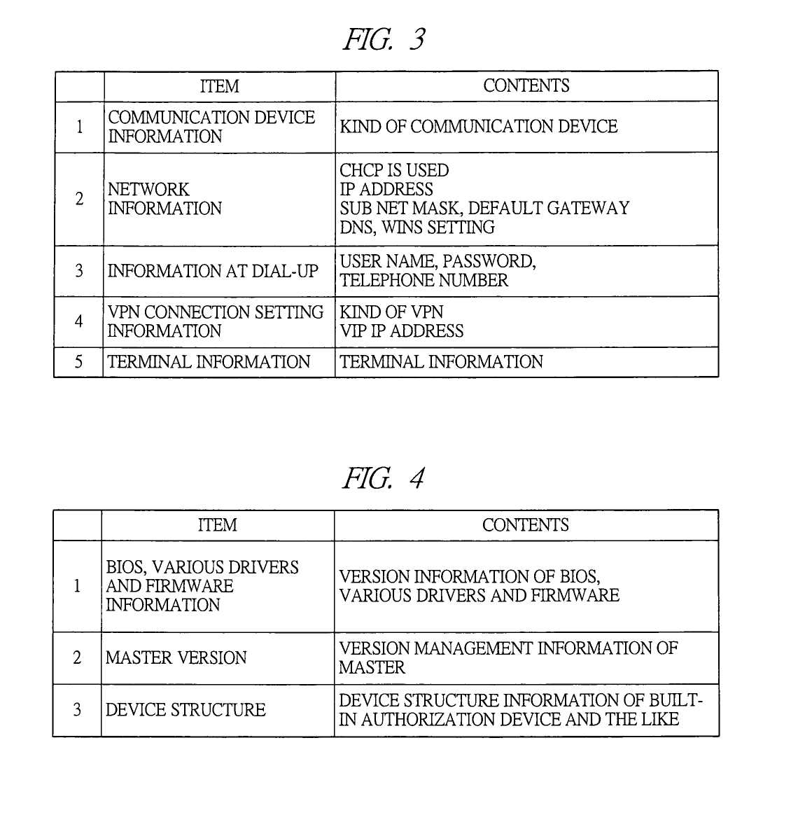

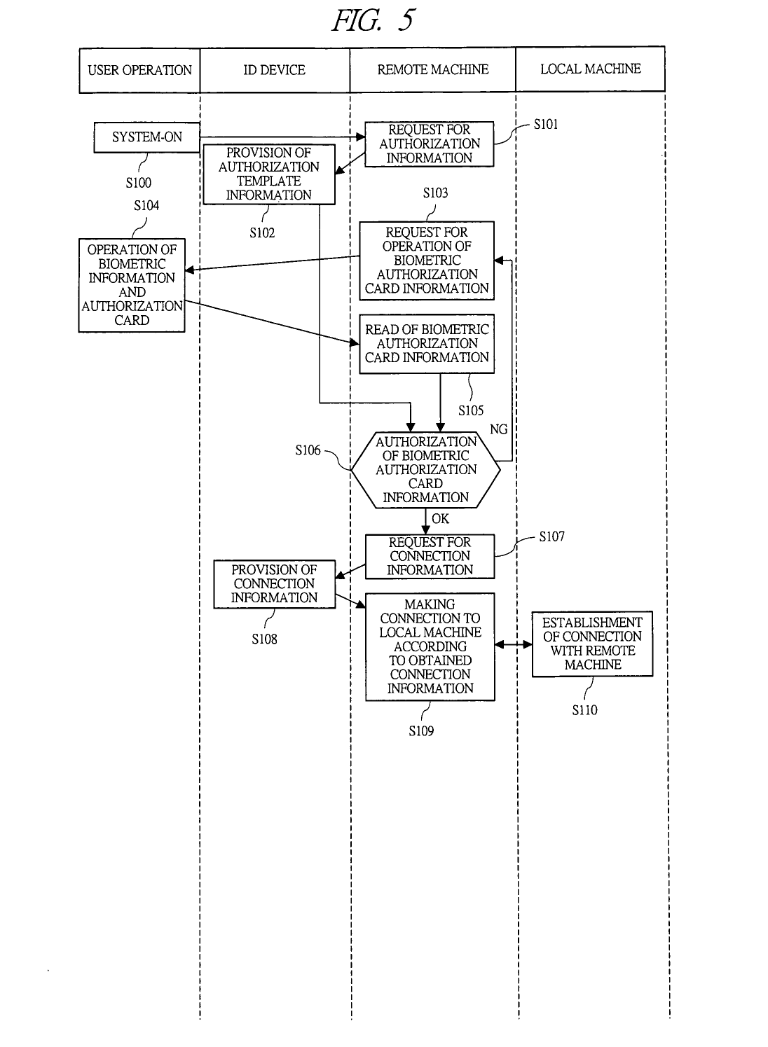

Next, with reference to FIG. 4, a structure of the device information 111 held in the remote machine 10 of the information processing system according to the embodiment of the present invention is explained. FIG. 4 is a diagram showing an example of the structure of the device information held in the remote machine 10 of the information processing system according to the embodiment of the present invention.

The device information 111 is structured of, as shown in FIG. 4, for example, BIOS, various drivers, firmware information, a master version and a device structure, and by transmitting the device information 111 to the management-authorization server 40, automatic processings of version-up and the like can be performed.

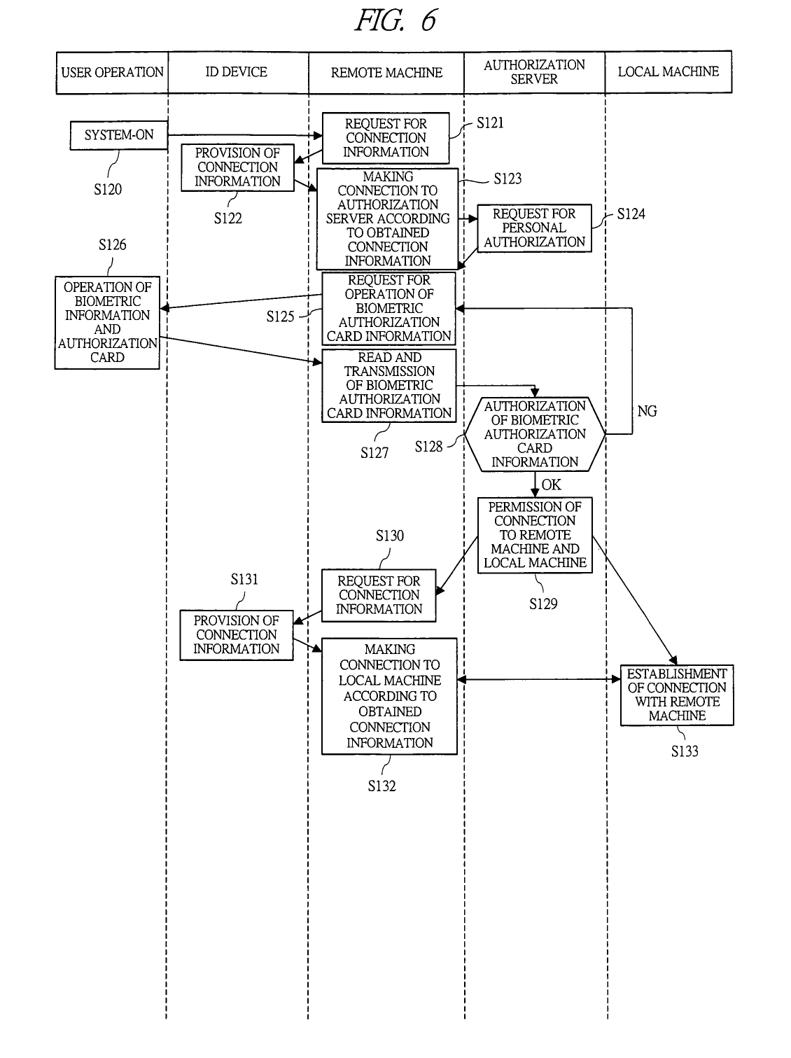

Herein, before explaining operation of the information processing system according to the embodiment of the present invention, operation of a conventional information processing system is explained with reference to FIG. 5 and FIG. 6 as an comparative example.

FIG. 5 and FIG. 6 are flow charts showing operation of comparative examples of the information processing system according to the embodiment of the present invention. FIG. 5 shows operation in a case where an authorization server is not provided and FIG. 6 shows operation in a case where the authorization server is provided.

First, in the case where the authorization server is not provided, as shown in FIG. 5, by user operation, system-on of the remote machine 10 is executed first (S110), and in the remote machine 10, authorization information is requested for an ID device of the remote machine 10 (S101), and the ID device of the remote machine 10 provides authorization template information to the remote machine 10 (S102).

And, the remote machine 10 requests biometric authorization card information for the user (S103), the user performs operation of biometric information and the authorization card (S104), the biometric authorization card information is read by the remote machine 10 (S105), and authorization of the biometric authorization card information is performed (S106).

If a result of the authorization at S106 is “NG”, the procedure goes back to S103, and if the result of the authorization at S106 is “OK”, connection information is requested for the ID device of the remote machine 10 (S107).

The ID device for which the connection information is requested provides the connection information to the remote machine 10 (S108), the remote machine 10 makes connection to the local machine 30 according to the obtained connection information (S109), and connection with the local machine 30 is established (S110).

Further, in the case where the authorization server is provided, as shown in FIG. 6, by user operation, system-on of the remote machine 10 is executed first (S120), and in the remote machine 10, authorization information is requested for the ID device of the remote machine 10 (S121).

The ID device for which connection information is requested provides the connection information to the remote machine 10 (S122), the remote machine 10 makes connection to the authorization server according to the obtained connection information (S123), and the authorization server requests personal authorization information for the remote machine 10 (S124).

The remote machine 10 for which the personal authorization is requested requests operation of the biometric authorization card information for the user (S125), the user performs operation of biometric information and the authorization card (S126), the biometric authorization card information is read by the remote machine 10, and transmission to the authorization server is performed (S127).

In the authorization server, authorization of the biometric authorization card information is performed (S128). If a result of the authorization at S128 is “NG”, the procedure goes back to S125, and if the result of the authorization at S128 is “OK”, connection to the remote machine 10 and the local machine 30 is permitted (S129).

In the remote machine 10 to which the connection to the local machine 30 is permitted, the connection information is requested for the ID device (S130).

The ID device for which the connection information is requested provides the connection information to the remote machine 10 (S131), the remote machine 10 makes connection to the local machine 30 according to the obtained connection information (S132) and the connection with the local machine 30 is established (S133).

As explained above, in the conventional information processing system, the connection information is stored in the ID device of the remote machine 10 and the connection information is provided to the remote machine 10 so that the connection of the local machine 30 is made.

Therefore, the ID device must be a device capable of storing the connection information, and IC devices to be various authorization cards cannot be used.

Further, in a case where many users share the remote machine 10, the connection destination is limited and optimum connection cannot be made.

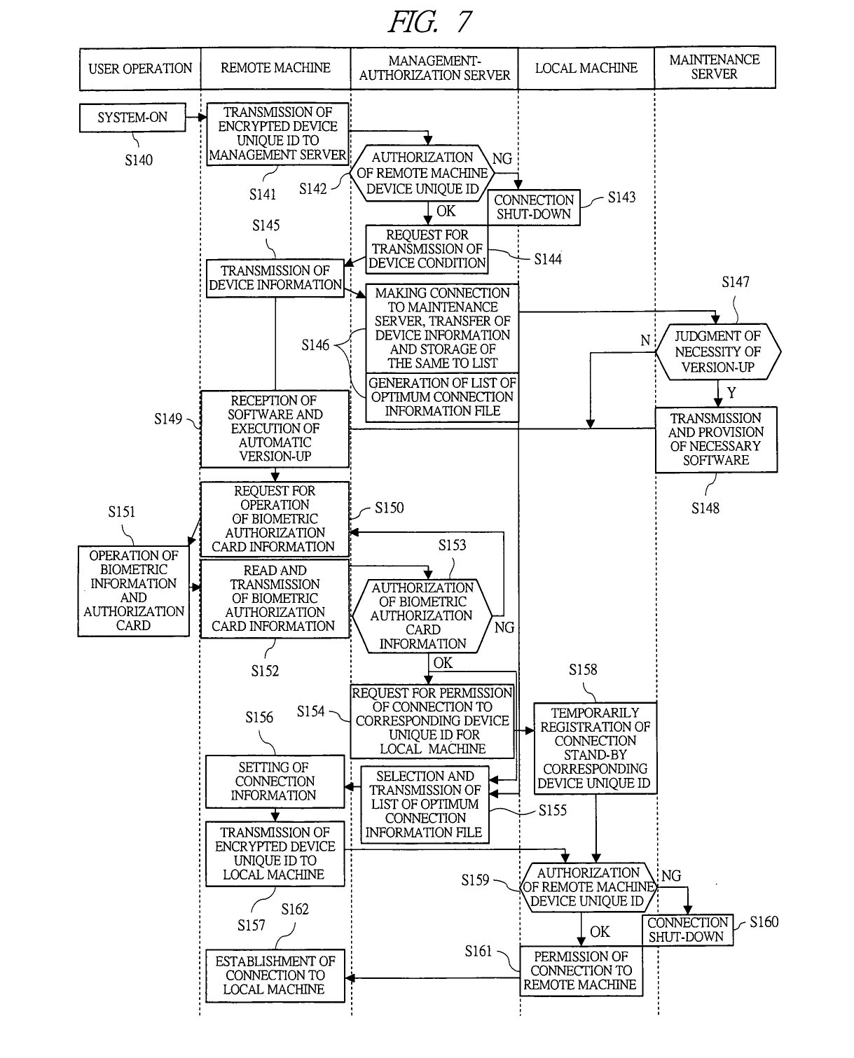

Next, with reference to FIG. 7, operation of the information processing system according to the embodiment of the present invention is explained. FIG. 7 is a flow chart showing operation of the information processing system according to the embodiment of the present invention.

First, system-on of the remote machine 10 is executed by user operation (S140), and in the remote machine 10, an encrypted device unique ID obtained by encrypting a device unique ID 110 is transmitted to the management-authorization server 40 (S141).

In the management-authorization server 40, according to the encrypted device unique ID, authorization of the device unique ID of the remote machine 10 is performed (S142). If a result of the authorization at S142 is “NG”, the connection is shut-down (S143), and if the result of the authorization at S142 is “OK”, transmission of device condition is requested for the remote machine 10 (S144).

In the remote machine 10, the device information 111 is transmitted to the management-authorization server 40 (S145), and the management-authorization server 40 makes connection to the maintenance server 50, transfers the device information 111 to the maintenance server 50, and stores the same to a management list (S146).

In the maintenance server 50, judgment of necessity of version-up is made according to the device information 111 (S147), and necessary software is transmitted and provided to the remote machine (S148). If judgment that the version-up is not necessary is made at S147, the necessary software is not transmitted.

In the remote machine 10, if the software is transmitted from the maintenance server 50, the software is received, automatic version-up is executed (S149), operation of the biometric authorization card information is required for the user (S150), the user performs operation of biometric information and the authorization card (S151), and the biometric authorization card information is read and transmitted to the management-authorization server 40 by the remote machine 10 (S152).

In the management-authorization server 40, authorization of the biometric authorization card information is performed (S153). If a result of the authorization at S153 is “NG”, the procedure goes back to S150, and if the result of the authorization at S153 is “OK”, connection permission of the remote machine 10 with corresponding device unique ID is requested for the local machine 30 (S154).

And, at storage into the management list at S146, a list of optimum connection information files 41 is generated, and after the result of the authorization at S153 becomes “OK”, the management-authorization server 40 selects the most optimum connection information file from the list of the optimum connection information file 41 and transmits the same to the remote machine 10 (S155).

The remote machine 10 sets the connection information (S156), and based on the connection information, transmits the encrypted device unique ID obtained by encrypting the device unique ID 110 to the local machine 30 (S157).

In the local machine 30, the corresponding device unique ID is temporarily registered as connection stand-by (S158) and authorization of the device unique ID of the remote machine is performed using the encrypted device unique ID (S159). If a result of the authorization at S159 is “NG”, the connection is shut-down (S160), and if the result of the authorization result at S159 is “OK”, connection to the remote machine 10 is permitted (S161) and the connection to the local machine 30 at the remote machine 10 is established (S162).

Note that, in the example shown in FIG. 7, in every time of making connection from the remote machine 10 to the local machine 30, the necessity of the version-up is judged by the maintenance server 50, however, in a case where the necessity of the version-up is judged only at making connection to the maintenance server 50 described later and the judgment is not performed at making usual connection to the local machine 30, the judgment of the necessity of the version-up by the maintenance server 50 and automatic version-up by the remote machine 10 can be set not to be performed.

And, in the generation of the list of the optimum connection information file 41 at S146, for example, when making connection from the remote machine 10 to the management-authorization server 40, an IP packet is transmitted to the management-authorization server 40, and in this IP packet, IP addresses of respective servers on a route are included. By the IP addresses of respective servers on the route, DNS is reversely looked-up (searched), and thereby affiliations of the servers are determined.

A server of the determined servers is checked against a list of servers and the like preliminarily generated, in the order of nearest to farthest from the remote machine 10, and thereby, a list of optimum connection information files 41 to the local machine 30 is generated.

And, as for selection from the list of the optimum connection information files 41, for example, the selection is performed by information such as connection information realizing high-speed connection.

Furthermore, it is possible to present the list of the optimum connection information files 41 to the user and select the most optimum connection information file 41 by operation of the user.

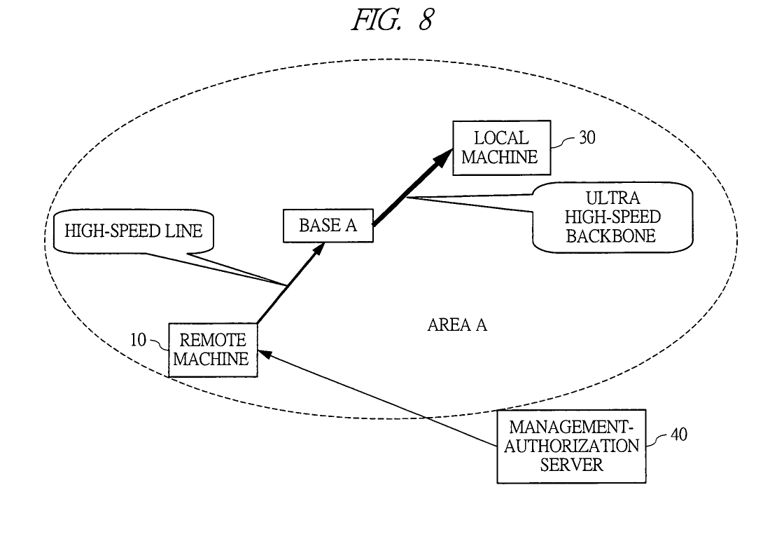

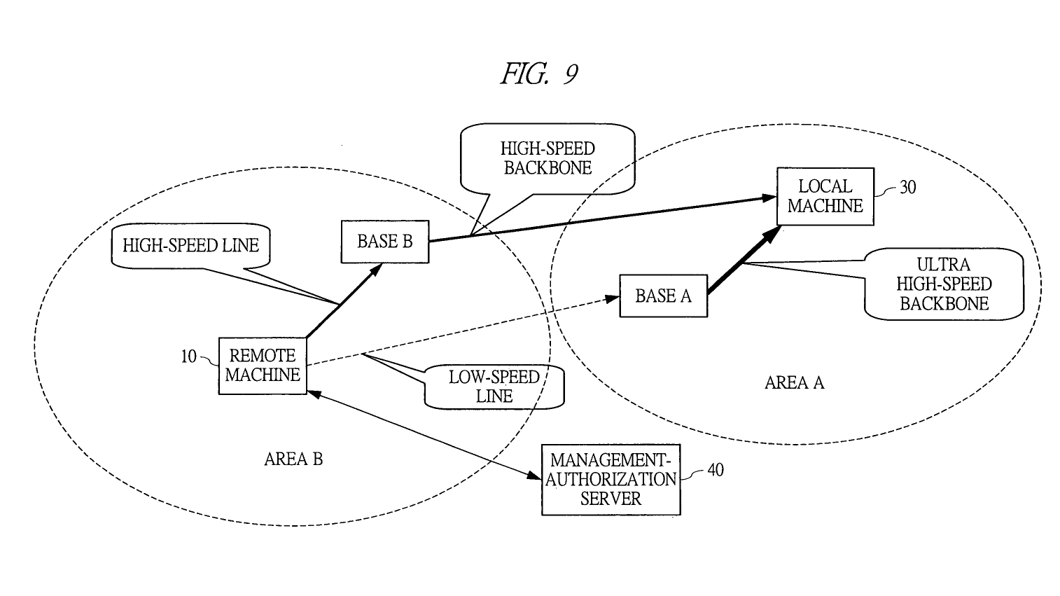

Next, with reference to FIG. 8 and FIG. 9, a concrete example of the selection of the most optimum connection information of the information processing system according to the embodiment of the present invention is explained. FIG. 8 and FIG. 9 are explanatory diagrams for explaining a concrete example of the selection of the most optimum connection information of the information processing system according to the embodiment of the present invention.

In FIG. 8, the remote machine 10 is usually used in an area A, and normally, connection is made from a base A in the area A to the local machine 30, the remote machine 10 and the base A are connected via a high-speed line, and the base A and the local machine 30 are connected by a ultra high-speed backbone.

And, in the usual area A, connection is made to the management-authorization server 40, optimum connection information is received, and connection from the base A to the local machine 30 via the ultra high-speed backbone is established.

However, as shown in FIG. 9, when connecting the remote machine 10 from an area B to the local machine 30, a line from the remote machine 10 to the area A is a low-speed line, and therefore, in the conventional connection as shown in FIG. 5 and FIG. 6, only connection by this low-speed line can be made. However, by connecting to the management-authorization server 40 and receiving the most optimum connection information, connection to the local machine 30 in the area A from a base B where connection by the high-speed line can be made via the high-speed backbone can be established.

Thus, by holding the connection information file 41 in the management-authorization server 40, irrespective of a location of existence of the remote machine 10, the most optimum connection information can be provided, and the connection to the local machine 30 can be established always in the most optimum connection environment.

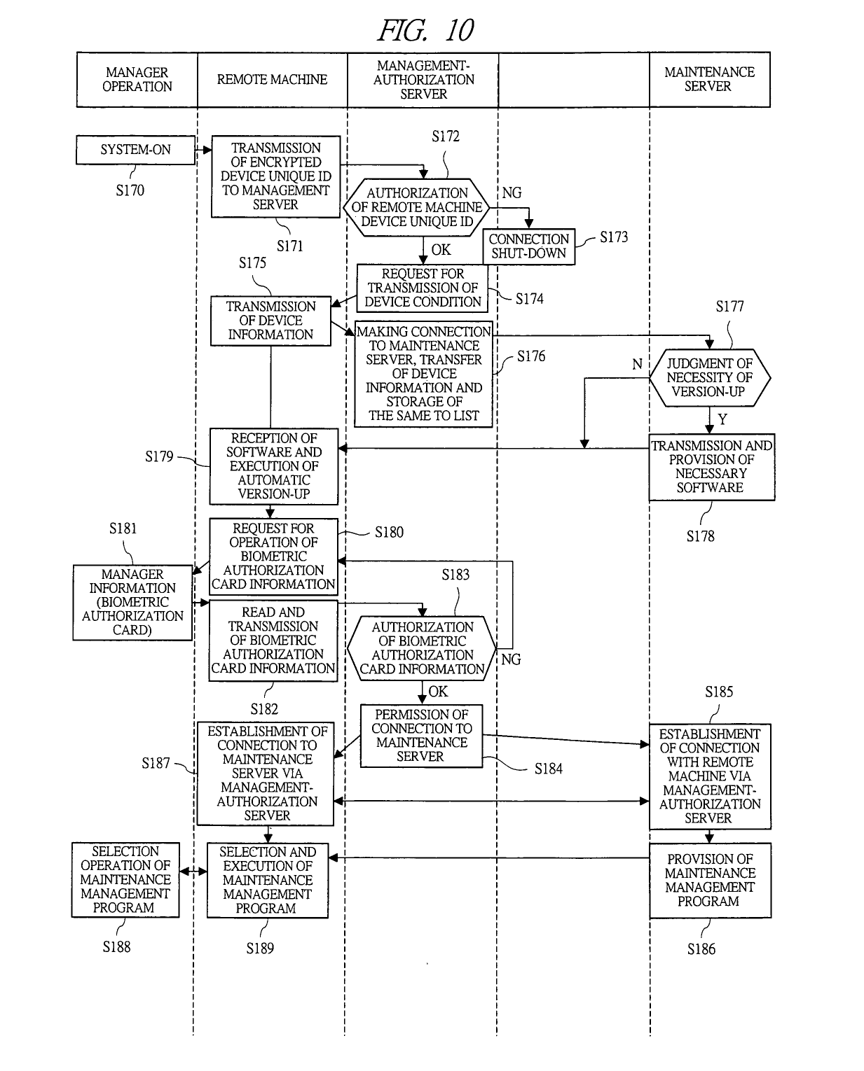

Next, with reference to FIG. 10, operation of the maintenance work of the information processing system according to the embodiment of the present invention is explained. FIG. 10 is a flow chart showing the operation of the maintenance work of the information processing system according to the embodiment of the present invention.

First, by manager operation by the user, system-on of the remote machine 10 is executed (S170), and in the remote machine 10, an encrypted device unique ID obtained by encrypting a device peculiar ID 110 is transmitted to the management-authorization server 40 (S171).

In the management-authorization server 40, using the encrypted device unique ID, authorization of the device unique ID of the remote machine 10 is performed (S172). If a result of the authorization at S172 is “NG”, the connection is shut-down (S173), and if the result of the authorization at S172 is “OK”, transmission of device condition is requested for the remote machine 10 (S174).

In the remote machine 10, the device information 111 is transmitted to the management-authorization server 40 (S175), and the management-authorization server 40 makes connection to the maintenance server 50, transfers the device information 111 to the maintenance server 50, and stores the same to management list (S176).

In the maintenance server 50, judgment of necessity of version-up is made according to the device information 111 (S177), and necessary software is transmitted to the remote machine and provided to the remote machine (S178). If judgment that the version-up is not necessary is made at S177, the necessary software is not transmitted.

In the remote machine 10, if the software is transmitted from the maintenance server 50, the software is received, automatic version-up is executed (S179), operation of the biometric authorization card information is requested for the user (S180), the user performs operation of biometric information and the authorization card (S181), and the biometric authorization card information is read and transmitted to the management-authorization server 40 by the remote machine 10 (S182).

In the management-authorization server 40, authorization of the biometric authorization card information is performed (S183). If a result of the authorization at S183 is “NG”, the procedure goes back to S180, and if the result of the authorization at S183 is “OK”, connection of the remote machine 10 to the maintenance server 50 is permitted (S184).

In the maintenance server 50, to the local machine 30, connection with the remote machine 10 via the management-authorization server 40 is established (S185), and a maintenance management program is provided to the remote machine 10 (S186).

Furthermore, the remote machine 10 establishes connection to the maintenance server 50 via the management-authorization server 40 (S187), and by selection operation of the maintenance management program by the user (S188), the maintenance management program is selected and executed (S189).

As described above, by holding the connection information file 41 in the management-authorization server 40, not only the connection to the local machine 30, but also the connection to the maintenance server 50 and the like become available, and update of driver, BIOS and the like of the remote machine 10 can be performed easily.

In the foregoing, the invention made by the inventor of the present invention has been concretely described based on the embodiments. However, it is needless to say that the present invention is not limited to the foregoing embodiments and various modifications and alterations can be made within the scope of the present invention.

What is claimed is:

1. An information processing system comprising:
a local machine performing an information processing;
a remote machine making connection to the local machine via a network and performing operation to the local machine by a user; and
a management-authorization server performing management and authorization of the remote machine,
wherein the management-authorization server includes plural pieces of connection information for the remote machine to make connection to the local machine, and
wherein the remote machine, at making connection to the local machine, makes connection to the local machine based on the connection information provided from the management-authorization server after the authorization by the management-authorization server.

2. The information processing system according to claim 1,
wherein the management-authorization server, at the authorization of the remote machine, selects optimum connection information from the plural pieces of the connection information to provide to the remote machine based on information of a connection location of the remote machine.

3. The information processing system according to claim 2,
wherein the information of the connection location of the remote machine is determined based on route information in an IP packet transmitted from the remote machine to the management-authorization server.

4. The information processing system according to claim 2,
wherein the optimum connection information is selected based on a connection distance between the remote machine and the local machine.

5. The information processing system according to claim 2,
wherein the optimum connection information is selected based on a communication speed between the remote machine and the local machine.

6. The information processing system according to claim 1,
wherein the management-authorization server, at the authorization of the remote machine, generates a list of plural pieces of optimum connection information from the plural pieces of the connection information based on information of a connection location of the remote machine and provides the generated list of the plural pieces of the optimum connection information to the remote machine, and
wherein the remote machine displays the list of the plural pieces of the optimum connection information provided from the management-authorization server and makes connection to the local machine based on optimum connection information selected from the displayed list of the plural pieces of the optimum connection information by the user.

7. The information processing system according to claim 1, further comprising:
a maintenance server performing maintenance of the remote machine,
wherein the management-authorization server, at the authorization of the remote machine, transmits device information of the remote machine to the maintenance server,
wherein the maintenance server makes judgment of necessity of version-up of the remote machine based on the device information of the remote machine and provides software for the version-up to the remote machine based on a result of the judgment, and
wherein the remote machine performs a processing of version-up based on the software for the version-up provided from the maintenance server.

8. The information processing system according to claim 7,
wherein the management-authorization server, at the maintenance of the remote machine by a maintenance management program from the maintenance server after the authorization of the remote machine, notifies permission of connection to the remote machine and the maintenance server respectively and establishes connection between the remote machine and the maintenance server.

9. The information processing system according to claim 1,
wherein the management-authorization server performs the authorization of the remote machine according to a device unique ID stored in a security chip loaded on the remote machine.

10. The information processing system according to claim 9,
wherein the management-authorization server performs authorization of the user according to an authorization card having only a certificate of the user stored, after the authorization of the remote machine.

11. A remote access method comprising the steps of:
transmitting a device unique ID of a remote machine from the remote machine to a management-authorization server;
authorizing the remote machine by the management-authorization server using the device unique ID;
requesting for the device-authorized remote machine to transmit device condition by the management-authorization server;
transmitting authorization information and authorization card information based on biometric information of a user from the remote machine to the management-authorization server;
performing authorization using the authorization information and the authorization card information based on the biometric information by the management-authorization server;
notifying permission of connection of the remote machine with the device unique ID from the management-authorization server to the local machine having the remote machine connected, according to a result of the authorization of the abovementioned step;
notifying information of connection from the remote machine to the local machine, according to the result of the authorization of the abovementioned step, from the management-authorization server to the remote machine; and
accessing the local machine from the remote machine based on the information of the connection.

12. The remote access method according to claim 11,
wherein the management-authorization server obtains a relay server on a route based on access information of the remote machine and notifies information of connection realizing high-speed connection between the local machine and the relay server.
